(19) United States
(12) Patent Application Publication
(10) Pub. No.: US 2013/0255822 A1
(43) Pub. Date: Oct. 3, 2013

(54) MICROFLUIDIC COMPONENT, REACTOR COMPRISING A PLURALITY OF SUCH COMPONENTS, AND METHOD FOR PRODUCING SAME

(71) Applicants: Martin Wichert, Bad Schwalbach (DE); Silvio Kraus, Nordhausen (DE)

(72) Inventors: Martin Wichert, Bad Schwalbach (DE); Silvio Kraus, Nordhausen (DE)

(73) Assignee: INSTITUT FUR MIKROTECHNIK MAINZ GMBH, Mainz (DE)

(21) Appl. No.: 13/992,938

(22) PCT Filed: Dec. 14, 2011
(86) PCT No.: PCT/EP2011/072724

§ 371 Date: Jun. 10, 2013

(30) Foreign Application Priority Data
Dec. 14, 2010 (DE) 10 2010 063 074.8

(51) Int. Cl. F16L 9/02

(52) U.S. Cl. CPC F16L 9/02
USPC 138/177; 72/368

(57) ABSTRACT

A microfluidic component made of a metal sheet having a structure which includes a closed fluid line and which is formed of a structured surface of a first section of the metal sheet and an adjoining structured or unstructured surface of a second section of the metal sheet, wherein the metal sheet is folded such that the sections integrally connected to each other are located on top of each other in a surface-parallel manner. The metal sheet further includes at least one third section having a contoured edge and is moreover folded such that the third section is also supported in a surface-parallel manner and the contoured edge forms a first wall section and the adjoining structured or unstructured surface of the first or second section forms a second wall section of an open fluid line. A microfluidic reactor comprising a plurality of such microfluidic components and a method for producing such components.

### FIELD OF THE INVENTION

The invention concerns, among other things, a microfluidic component made of a metal sheet having a structure which comprises a closed fluid line. By “microfluidic component” or component with a microfluidic structure is meant in the context of this document a component of a modular-design microreactor, micro heat exchanger, micromixer or the like, in which a microstructure incorporated in the surface of the component, such as channels, pockets or other depressions, generally called fluid lines, have dimensions in the nanometer range to the millimeter range, especially lateral dimensions of 100 nm to 1 mm. By lateral dimension is meant at least one dimension transverse to the major direction of flow. The above specifications in the case of broad structures like pockets refer to their smallest dimension, i.e., their profile depth. Any boreholes through the metal sheet are not counted as surface structures in the sense of this definition.

### BACKGROUND OF THE INVENTION

“Fluid line” in the sense of this document is used as a generic term for all cavities of any given geometrical shape to hold and/or convey a fluid. Examples are pockets, channels, tubes or the like. A distinction is made between open and closed fluid lines. By “open fluid line” is meant here those fluid lines that are open at least on one end, apart from any inlets and/or outlets. On the contrary, by a “closed fluid line” is meant a cavity bounded on all sides by wall sections, except for any inlets and/or outlets.

A microfluidic structure and a method for its production are described in the document DE 101 08 469 B4. With the embossing method disclosed there, various open structure elements can be embossed into the surface of the metal sheet. This results in microfluidic components with open fluid lines. In the sense of the definitions given above, the microfluidic component made according to this teaching should therefore not be subsumed under the generic concept of the patented object of claim 1, since it has no closed fluid line.

A closed fluid line and its production are known, for example, from DE 196 43 934 A1. The outcome of the manufacturing process is a sheet metal assemblage of two metal sheets that are merged together and both run through a calibrating unit, one of them having been previously embossed with a wave profile by means of two intermeshing profiling rolls. Several such sheet metal assemblages are then stacked one on top of another so that the sheet with the wave profile and the smooth sheet always alternate, wound up, and used as a honeycomb body in a jacketed tube, for example, to serve as a catalytic converter in the exhaust systems of motor vehicles. Although the document discusses the production of structured metal sheets, these are evidently not to be considered as microfluidic components. Yet the method described there can essentially be applied to microfluidic components as well. However, the method is suited almost exclusively to the production of just such honeycomb bodies. Other, more complex structures cannot be made by the manufacturing methods described there.

A very similar makeup of a reactor for a catalytic reaction is known from the document EP 0 885 653 A2. The reactor is of stack shape and is made from a meandering folded partition wall and corrugated sheet metal elements inserted in the resulting folds. The different structures here are also limited only to different cross sectional forms of the wave profile.

Moreover, if structure element situated transversely to the wave structure for distribution of the fluid (distributing channels) or other fluid lines need to be provided, it is not evident how these could be easily configured.

A heat exchanger is known from WO 2005/088223 A1, which is assembled from a plurality of stacked and interconnected, especially welded, oblong disks. The disks, in turn, consist of two disk halves that are folded along a bending edge so that the two half surfaces lie parallel on top of each other and enclose a cavity in the form of a plurality of grooves for conducting a medium being cooled through it.

From DE 10357082 B3 is known a spiral heat exchanger with a guide component made from a rectangular foil element that is folded in half along a folding line and then rolled together about the folding line. The foil element is divided into two halves along the folding line, one half having recesses on one side of the surface and the other half on the opposite side of the surface, extending as fluid passages from the folding line to the edge of the foil element situated opposite the folding line.

Besides the methods known from the cited documents, many material-removing methods are known for the production of microfluidic structures. They are based on electrical, chemical, electrochemical or mechanical material-removing processes. However, these methods have the common drawback that the processing requires a relatively long time and therefore an economical mass production does not seem to be possible.

### SUMMARY OF THE INVENTION

Against this background, the problem of the present invention is to provide a simple microfluidic component with a greater diversity of structural features, a microfluidic reactor with several such components, and an economical method for their production.

The problem is solved on the one hand by microfluidic components made from a metal sheet with at least one first and/or second section having a structured or unstructured surface and at least one third section having a contoured edge which is folded such that the first and third and/or second and third sections integrally connected to each other are located on top of each other in a surface-parallel manner and the contoured edge forms a first wall section and the adjoining structured or unstructured surface forms a second wall section of an open fluid line, by a microfluidic component made of a metal sheet having a structure which comprises a closed fluid line, wherein the closed fluid line is formed of a structured surface of the first section of the metal sheet and an adjoining structured or unstructured surface of the second section of the metal sheet, wherein the metal sheet is folded such that the first and second sections integrally connected to each other are located on top of each other in a surface-parallel manner; by a microfluidic reactor, wherein several microfluidic components are stacked and connected fluid-tight along their circumference except for specified openings; and by the method for making a microfluidic component, wherein a metal sheet with at least one first and/or second section having a structured or unstructured surface and at least one third section having a contoured edge is folded so that the third section with the contoured edge comes to lie surface-parallel on top of the first and/or second section with the structured or unstructured surface and the contoured edge forms a first wall section and the adjoining (after the folding) structured or unstructured surface forms a second wall section of an open fluid line, and a method for production of a microfluidic component, wherein a metal sheet with at least one first section having a structured surface and at least one second section having a structured or unstructured surface is folded so that the first section comes to lie surface-parallel on top of the second section and the structured surface of the first section together with the adjoining structured or unstructured surface of the second section form a closed fluid line. Advantageous modifications are the subject of the subclaims.

According to a first aspect of the invention, the microfluidic component made of a metal sheet having a structure which comprises a closed fluid line is characterized in that the closed fluid line is formed of a structured surface of a first section of the metal sheet and an adjoining structured or unstructured surface of a second section of the metal sheet, wherein the metal sheet is folded such that the sections integrally connected to each other are located on top of each other in a surface-parallel manner.

By “section of the metal sheet” is meant here a part of a cohesive single-piece metal sheet. The term “surface” in the sense of the document is a surface on the top or bottom side of the respective section of the metal sheet. By “unstructured surface” is meant a surface without functional structuring. Manufacturing-produced structures of a blank, such as the roughness of a brushed, polished or rolled metal sheet or the like and not such a functional structuring. Such surfaces are therefore called unstructured. On the contrary, by “structured surface” is meant herein a surface with a microfluidically functional, specifically introduced surface structure, such as fluid lines.

The corresponding method of the invention for production of a microfluidic component calls for folding a metal sheet with at least one first section having a structured surface and at least one second section having a structured or unstructured surface so that the first section comes to lie surface-parallel on top of the second section and the structured surface of the first section together with the adjoining structured or unstructured surface of the second section form a closed fluid line.

Unlike the known prior art, the microfluidic component of the invention made from two integrally connected sheet metal sections lying surface-parallel one on top of the other is formed by folding the metal sheet in simple fashion along a folding edge. As a result, one can produce a more complex component with one or more closed fluid lines in simple manner. It is also advantageous that the microfluidic component, being a single piece, is easier to process further, for example, into a microfluidic reactor.

It is advantageous in the method to make the structured surface in an embossing step prior to the folding process. Especially preferably, the structured surface is made by embossing a corrugated structure.

In both of the ways described above, with the use of embossing and forming methods known in themselves, one can make an economical microfluidic component which can be used to realize a plurality of structures, especially open and closed fluid lines.

The term “embossing” is used here as a generic term for all forming methods with which a metal sheet can be given a surface structure. This can be, in the sense of embossing (pressure forming), the creating of depressions on only one side of the metal sheet, while the opposite side remains smooth or is given a different structure. This also includes deep-drawing, a combination of stretch-forming and deep-drawing (tensile compression reshaping) of the metal sheet between a punch and a die or the bending of the metal sheet, for example, between two intermeshing profiled rolls, wherein the metal sheet is given complementary structures on the front and rear sides. For simplicity, we shall speak here of an “embossed surface” in general.

According to a second aspect of the present invention, the microfluidic component has a metal sheet with at least one (third) section having a contoured edge and at least one (first and/or second) section having a structured or unstructured surface, such that the (first and third or second and third) sections integrally connected to each other are located on top of each other in a surface-parallel manner and the contoured edge forms a first wall section and the adjoining structured or unstructured surface forms a second wall section of an open fluid line.

The corresponding method of the invention for making a microfluidic component calls for folding a metal sheet with at least one (third) section having a contoured edge and at least one (first and/or second) section having a structured or unstructured surface so that the (third) section with the contoured edge comes to lie surface-parallel on top of the (first and/or second) section with the structured or unstructured surface and the contoured edge forms a first wall section and the adjoining (after the folding) structured or unstructured surface forms a second wall section of an open fluid line.

The term “edge” in the sense of this document means a surface along the margin of the metal sheet that is generally perpendicular to the main plane of the sheet and that is produced, for example, when the metal sheet is punched out. “Margin of the metal sheet” means the border of the metal sheet projected perpendicular to its main plane. A “contoured edge” in the sense of this document can be a straight edge in the simplest case. The contoured edge generally follows any given functionally required or desired curve. The terms “wall” and “wall section” mean here a spatial boundary element of a fluid line. On the other hand, the fluid line is as a rule defined by several wall sections.

Preferably, the contoured edge is produced in a punching step prior to the folding process.

In this way, by the use of embossing and forming techniques, combined with punching techniques, one can make an economical microfluidic component that can be used to realize a plurality of structures, especially open fluid lines.

According to an especially preferred variant of the invention, the microfluidic component combines both of the aforementioned aspects. In this case, the closed fluid line is formed from a structured surface of a first section of the metal sheet and an adjoining structured or unstructured surface of a second section of the metal sheet, as described above. Moreover, the metal sheet has at least one third section with a contoured edge and is folded so that the integrally connected first and third and/or second and third sections lie surface-parallel one on top of the other and the contoured edge of the third section forms a first wall section and the adjoining structured or unstructured surface of the first or second section forms a second wall section of an open fluid line.

The corresponding method of the invention calls for folding a metal sheet with at least one first section having a structured surface and at least one second section having a structured or unstructured surface as described above, wherein the metal sheet has a third section having a contoured edge, and moreover it is folded such that the third section with the contoured edge comes to lie surface-parallel on top of the first and/or second section with the structured or unstructured surface and the contoured edge forms a first wall section and the adjoining (after the folding) structured or unstructured surface forms a second wall section of an open fluid line.

The combining of the benefits of both aspects of the invention enables the making of an even greater variety of structure elements. Most particularly preferred is a folding of the sheet metal such that the closed fluid line forms a closed channel into which the open fluid line empties.

One specific embodiment of a correspondingly folded microfluidic component is characterized in that the open fluid line is a collecting or distributing structure for bringing together a fluid from several closed channels or for distributing the fluid among several closed channels. By a collecting structure is meant a structure that is usually broad in the beginning and narrows in the direction of flow, into which several closed channels empty, and in which the fluid is brought together from these channels and delivered to one or more drain lines. Similarly, by a distributing structure is meant a structure usually widening out in the flow direction, into which one or more incoming lines empty and from which the fluid from these incoming lines is distributed to the several closed channels. Distributing and collecting structures hence differ primarily by their function, due to the direction of flow of the fluid. In structure, they may be identical.

The term “channel” here is used to describe a lengthwise extending, usually capillary fluid line. Therefore, by “closed channel” is meant a tubular fluid line bounded about its circumference except for an opening at the inlet and outlet end. “Open channel” accordingly describes a groovelike fluid line open at least on one side in terms of circumference.

The above-described microfluidic component can be made especially economically and efficiently by a method in which punching, embossing and folding occur in succession in a progressive composite die. This even allows for a mass production.

The microfluidic component is modified in respect of a reactor application in that the structured surface of the first section and/or the structured or unstructured surface of the second section is coated at least in the region of the closed and/or open fluid line. Preferably, however, only the structured surfaces are coated, since the catalyst usually adheres worse to the unstructured surfaces and furthermore no exothermal or endothermal chemical reactions should take place in regions of unstructured surfaces.

Accordingly, the method of the invention is advantageously modified such that the structured surface of the first section and/or the structured or unstructured surface of the second section is coated at least in the region of the closed and/or open fluid line.

The coating process can occur on the rough blank, after the structuring of the surface, or on the finished microfluidic component, depending on the toughness of the layer being deposited and the complexity of the component. Preferably the surface is coated in the silk screen process.

Another aspect of the present invention concerns a microfluidic reactor made from several microfluidic components of the above-described kind, which are stacked and connected fluid-tight along their circumference, except for specific openings. This microfluidic reactor is manufactured in a process in which several microfluidic components of the above-described kind after the folding process are stacked one on top of another and connected fluid-tight along their circumference, except for specific openings.

Microfluidic reactor comprises here microreactors for chemical or biochemical processes, micro heat exchangers, or also micromixers.

As the connection, one can consider a soldered connection, but preferably a welded connection if a solder connection is in conflict with a catalyst material, for example. The several microfluidic components are especially preferably laser-welded.

In a corresponding microfluidic reactor, preferably at least one of the several microfluidic components with an open fluid line in the above-given sense adjoins a neighboring microfluidic component such that the open fluid line and the structured or unstructured surface of a first or second section of the adjoining component form a closed fluid line.

In other words, only when the microfluidic components are assembled into a stack reactor is the desired overall microfluidic structure completely produced.

For the microfluidic components in general and for those intended for use in microfluidic reactors, one will prefer thin rolled metal sheets with material thicknesses between typically 0.1 mm and 1 mm. Depending on whether an embossed surface structure or a corrugated drawn or bent surface structuring is at hand, a thicker or thinner material thickness will be of advantage. For metal sheets with corrugated structured sections, sheet thicknesses between 0.1 mm and 0.5 mm and especially preferably between 0.1 mm and 0.3 mm have proven to work well.

The width of the open or closed fluid lines formed can vary according to the application. In the case of open or closed channels, the width and depth is preferably in the range of 100 nm to 1 mm, especially preferably between 25 μm and 1 mm. In the case of broad of pocketlike structures, such as distributing structures, at least the depth of the structure lies in the indicated ranges.

### BRIEF DESCRIPTION OF THE DRAWINGS

Further features and benefits of the present invention will be explained more closely below by means of sample embodiments with the help of drawings. There are shown:

FIGS. 1A to 1F, the making of the invented microfluidic component in six individual steps;

FIGS. 2 to 5, cross sections of different embodiments of the microfluidic component after the folding;

FIG. 6, an exploded drawing of a microfluidic reactor, consisting of various microfluidic components;

FIG. 7, a cross section through a stack of coated microfluidic components according to a first embodiment;

FIG. 8, a cross section through a stack of coated microfluidic components according to a second embodiment; and

FIG. 9, a cross section through a stack of coated microfluidic components according to a third embodiment.

### DETAILED DESCRIPTION OF THE INVENTION

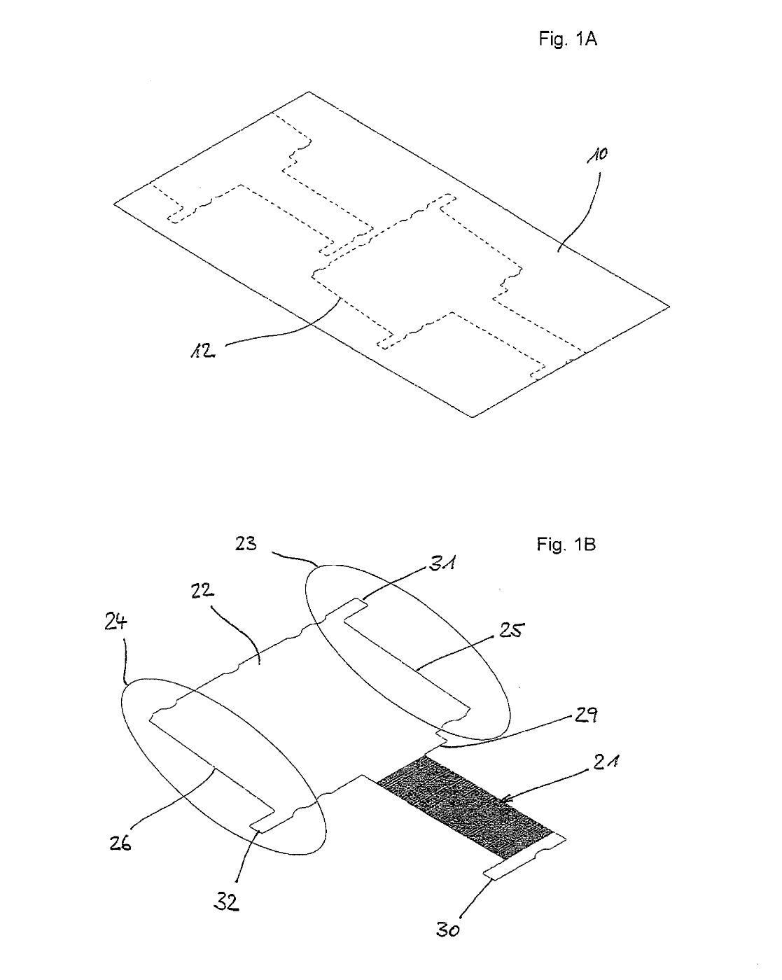

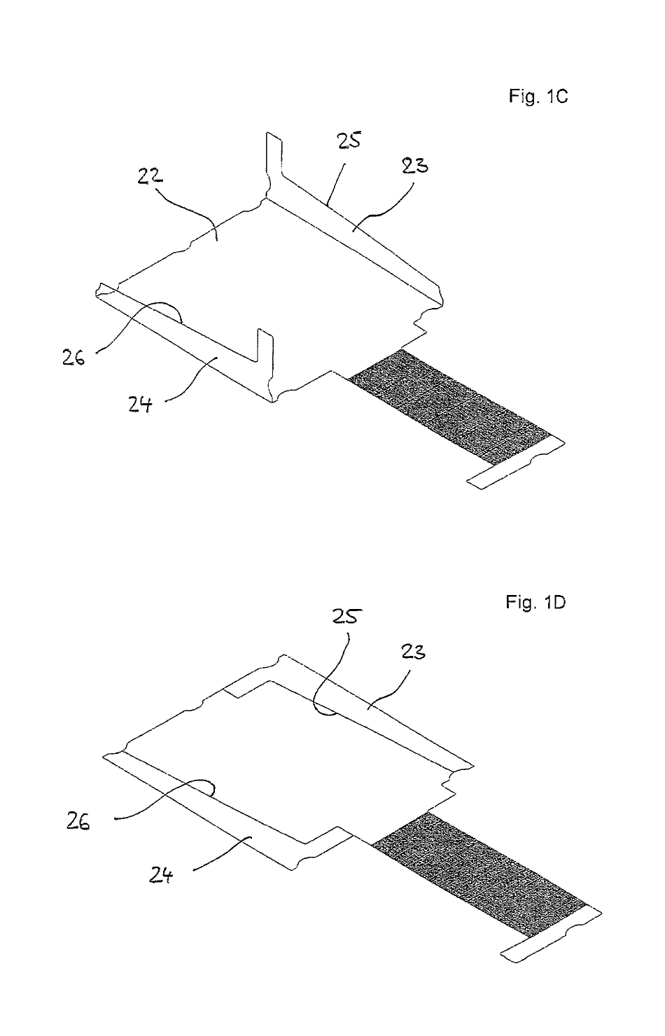

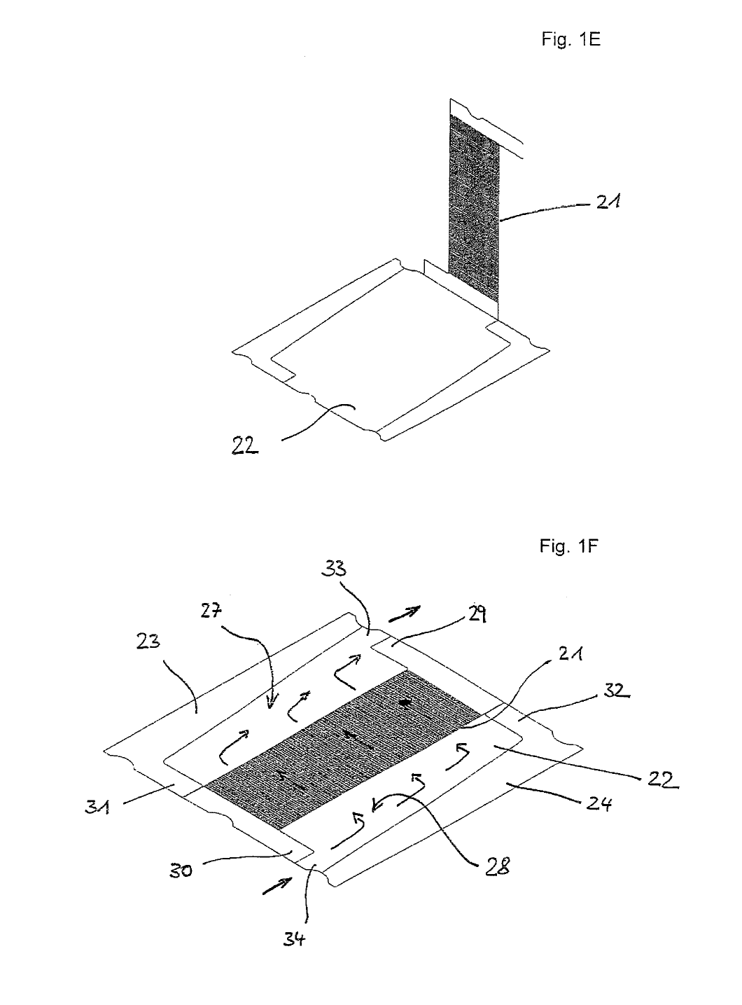

FIGS. 1A to 1F show in sequence a plate, a rough blank, intermediate products, and the end product of a microfluidic component manufactured according to the method of the invention.

FIG. 1A shows a cutout of a metal strip 10, preferably a refined steel sheet, from which rough blanks with defined exterior geometry for the manufacture of the microfluidic component are separated along the dotted contour line 12. “Separated” is used here as a generic term for various separation processes, such as punching, sawing, grinding, laser cutting or shearing, of which punching is preferred. The metal strip can for example be unwound in the form of a long band, almost continuously from a so-called “coil”.

Instead of the metal strip as sketched in FIG. 1A, several blanks can also be punched out from a broader sheet, or individual blanks each from a separate plate. The choice of the starting form of the material will be geared to the margin, the availability of machinery/equipment, the required exterior geometry of the blank and the concomitant optimization of the cutting pattern (minimizing waste), in brief, the economy of the manufacturing process.

Requirements for the material as such are fluid-tight soldering or welding capability, especially by means of laser welding, good adherence of the catalyst material, and thermal resistance for the reaction temperatures.

The punching out of the blank is not necessarily part of the manufacturing method of the invention, for example, when a prefabricated blank is the starting material. When using a progressive composite die in which the punching is integrated as a process step, however, it can also be counted as part of the manufacturing method of the invention. The punching itself can take place in several steps. The punching and the embossing can occur in any given sequence.

Starting with the blank produced in one way or another, one arrives at the interim result depicted in FIG. 1B, which is functionally divided into a first section 21 with structured surface, an adjoining second section 22 with unstructured surface, and two third sections 23 and 24 each with a contoured outer edge 25 and 26. The structured surface of the first section 21 has open microchannels perpendicular to the longitudinal direction of the section 21.

The microchannels can be embossed in one side of the sheet section after the dividing is done, or they can be introduced by one of the known chemical, electrical, electrochemical or mechanical material-removing methods. Although the latter methods are less common in mass production, the present invention does not rule out such a processing step. Of course, embossing methods when they provide the desired outcome are to be preferred for an economical (mass) production.

Alternatively to a microstructure introduced on one side, the structuring can also constitute a corrugated profile of the entire sheet section. That is, a complementary surface structure is fashioned on both opposite sides of the sheet section. The forming method used here will be deep-drawing, a combination of stretch forming and deep-drawing, or profile rolling (bending).

In what follows, FIGS. 1C and 1D will be used to describe the forming process in which the metal sheet is folded along defined bending lines (not shown) in two work steps by 90° each time, until the third sections 23 and 24 lie surface-parallel on top of the unstructured second section 22. This situation is depicted in FIG. 1D. In this state, ledges are formed along the contoured edges 25 and 26 of the third sections 23 and 24 relative to the unstructured surface of the first section 22.

In two subsequent work steps, the metal sheet is folded along a defined bending line (not shown) by 90° each time until the first, structured section 21 of the sheet comes to lie surface-parallel on top of the second, unstructured section 22 of the sheet. This state is depicted in FIG. 1F. In this state, the microfluidic component is finished.

The first, second and third sections continue to be joined as a single piece. The microchannels that were open prior to the folding on the surface of the first section 21 turned toward the viewer form closed channels after the folding on the surface now facing the second section 22, together with the unstructured surface of the second section 22.

The contoured edges 25 and 26 of the third sections 23 and 24 form first wall sections in the folded state of FIG. 1F, which stand essentially perpendicular on the unstructured surface of the second section 22. The unstructured surface of the second section 22 itself forms a second wall section each time. The two wall sections define an open fluid line in the form of two depressions 27 and 28, separated by the first section 21.

The first section 21 has a projection 29 and 30 at its end adjoining the second section 22 and at its end away from the section 22. The two third sections 23 and 24 each have projections 31 and 32 with similar geometry, each of them defining part of the contoured edges in the sense of the invention. The projections 29 and 30 also define contoured edges in the sense of the invention. All four projections together bound the depressions 27 and 28 at their long-side ends, except for a diagonally opposite opening 33 and 34, serving as inlet and drain for a fluid. The depressions 27 and 28 each form open fluid lines in the sense of this document. The depression 28 serves as a distributing structure to distribute the flow of the fluid, which gets for example through the opening 34 (inlet) into the region of the depression 28, where it is distributed to the closed channels emptying into the depression 28 between the first section 21 and the second section 22, and transported by these channels into the second open fluid line 27. Thus, the depression 27 serves as a collecting structure for bringing together the fluid from the closed channels emptying into the depression 27. The collected fluid is finally taken off through the opening 33 (drain). The arrows indicate the flow process. The distributing structure 28 and the collecting structure 27 differ only in their function, owing to the flow direction of the fluid. Structurally, they are identical.

FIGS. 1A to 1F demonstrate that the invention satisfies the claim of series manufacture in that the individual microfluidic components can be produced by industrially established sheet metal machining techniques, wherein the microstructure of the component so produced need not be confined to microchannels, but can also involve microstructure elements such as the flow distributor, chosen as an example.

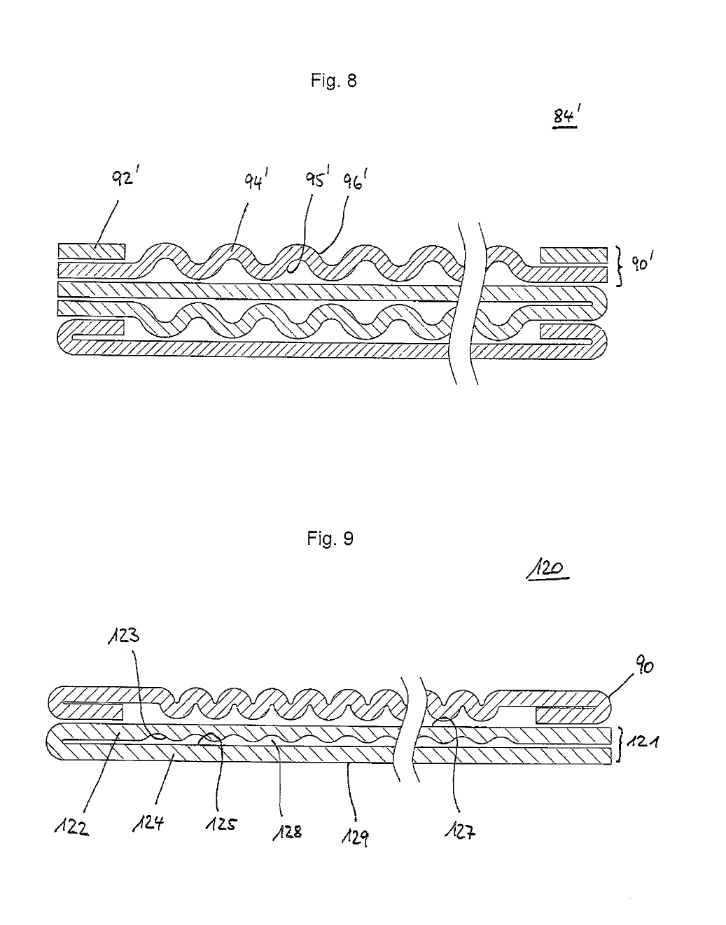

The microfluidic component of FIG. 1F, for example, can be used as a module in microfluidic reactors in the broad sense. In such microfluidic reactors, several such modules with the same or different structuring and function are stacked one on top of another. The adjacent modules are configured such that each component with an open fluid line is closed by the (structured or unstructured) surface of the adjacent neighboring module. Specifically for the closing, microfluidic components in the sense of the invention can be configured as cover elements. What this means shall be explained below with reference to FIGS. 7 and 8.

Depending on the application purpose of the microfluidic reactor, preferably the microstructured surface of the first section 21 and/or in rare cases the unstructured surface of the second section 22 of the module of Fig. F is coated with a catalyst. A silk screen technique is used preferably as the coating method.

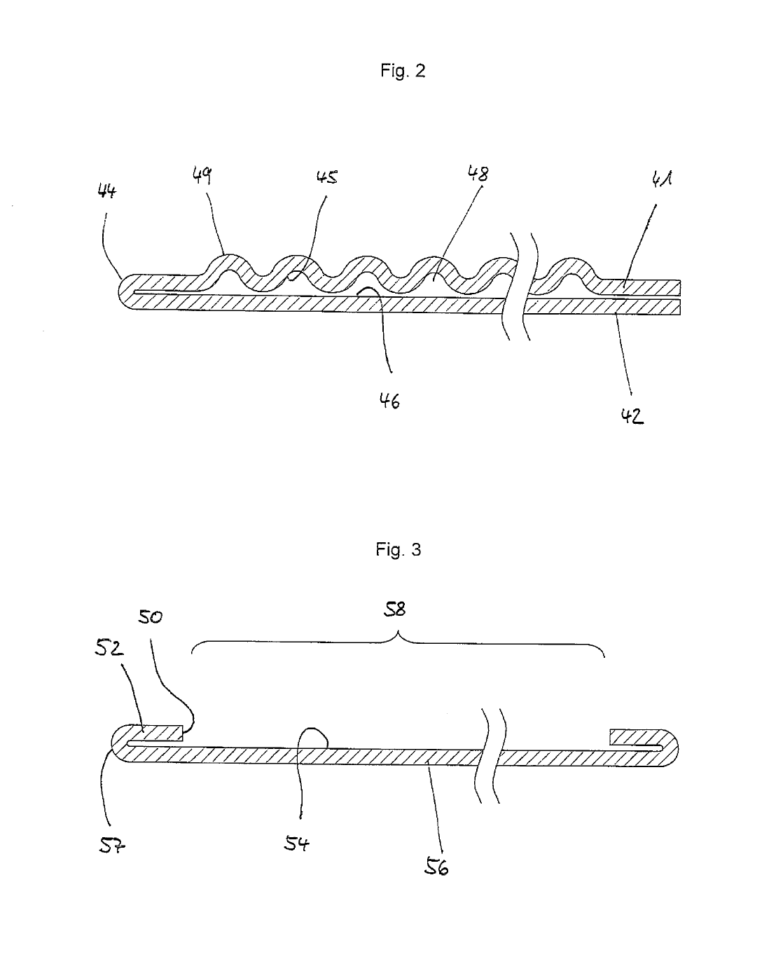

In FIGS. 2 to 5, views of four different combinations of folded sections are shown as examples, illustrating microfluidic components according to the invention. FIG. 2 shows the view of a microfluidic component in which the metal sheet has a first section 41 with structured surface and a second section 42 with unstructured surface. The sheet is folded along a folding edge 44 such that the two sections 41 and 42 connected as a single piece lie surface-parallel one on top of another. In this way, the structured surface 45 on the underside of the first section 41 together with the unstructured surface 46 on the top side of the second section 42 form closed fluid lines 48. The first section 41 is structured with corrugations, so that even on its surface 49 facing upward it has structural elements that also form open fluid lines after the folding.

The sample embodiment of a microfluidic component, as shown in FIG. 3, consists of a metal sheet with a section 52 having a contoured edge 50 and a section 56 having an unstructured surface 54. The sheet is folded along a bending edge 57 such that the integrally connected sections 52 and 56 lie surface-parallel one on top of another and the contoured edge 50 forms a first wall and the adjoining unstructured surface 54 of section 56 forms a second wall section of an open fluid line 58.

The microfluidic component of FIG. 1A to 1F combines both aspects of the invention as explained by FIGS. 2 and 3.

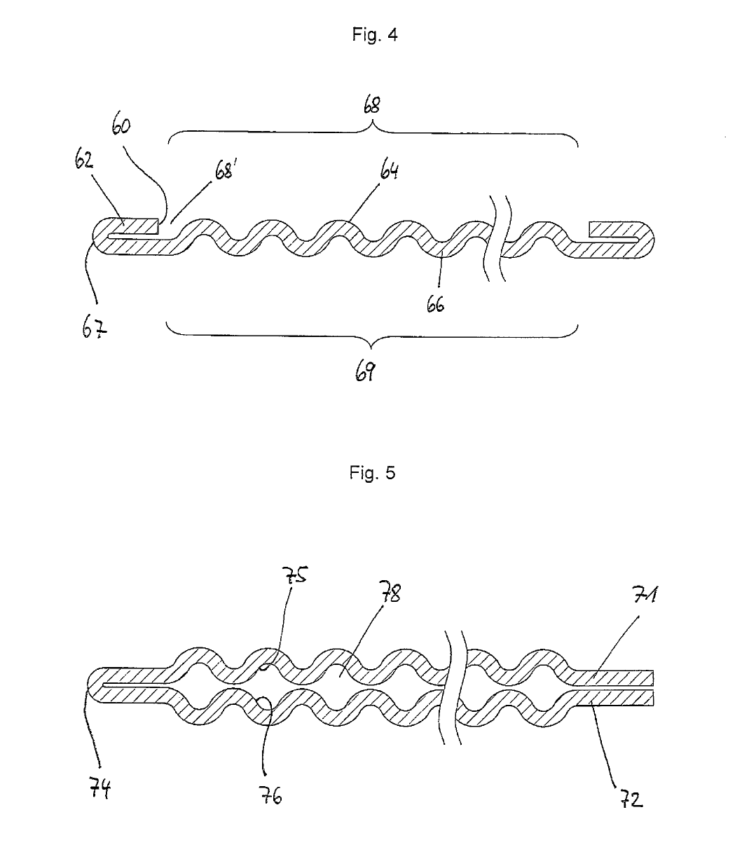

The sample embodiment of a microfluidic component per FIG. 4 is constructed similar to that of FIG. 3. It consists of a metal sheet with a section 62 having a contoured edge 60 and a section 66 having a structured surface 64—differing in this respect from FIG. 3. The two sections 64 and 66 are folded in similar manner along a folding edge 67 so that they lie surface-parallel one on top of another and the contoured edge 60 forms a first wall section and the adjoining structured surface 64 forms a second wall section of an open fluid line 68. Thanks to the corrugated structuring, several open fluid lines are formed on the surface 64, only the first fluid line 68′ being bounded by the contoured edge 60. The structuring of the section 66 is likewise corrugated, so that the structured surface on the underside of section 66 provides its own open fluid lines 69.

The invented microfluidic component of FIG. 5 consists of a metal sheet with a first section 71 and a second section 72 that is folded along a bending edge 74 such that the integrally connected sections 71 and 72 lie surface-parallel one on top of another. The first section 71 has a structured surface 75 and the second section 72 likewise has a structured surface 76. The structured surfaces 75 and 76 after the folding adjoin each other and form closed fluid lines 78.

As is evident, any desired structural elements can be embossed in the surfaces in each of the layouts shown in FIGS. 2 to 5, so that a variety of open or closed fluid lines can be produced. In particular, it should be noted that the structured sections 1 and 2 shown in FIGS. 2 to 5 each have corrugated structures, such as can be created for example by bending or deep-drawing a metal sheet, so that the structural features on the two surfaces of the sections are complementary to each other. But this is only one option. As mentioned above, the corresponding sections 1 and 2 can also have structures embossed on one side. An example of this will be explained with reference to FIG. 8.

In all examples illustrated here, the third sections 23, 24 52 or 62 are short relative to the bending edge and are folded along a relatively long bending edge. However, this is obviously not compulsory. The skilled person can select the cutting and folding pattern entirely according to his requirements and in regard to a material-economizing cutting.

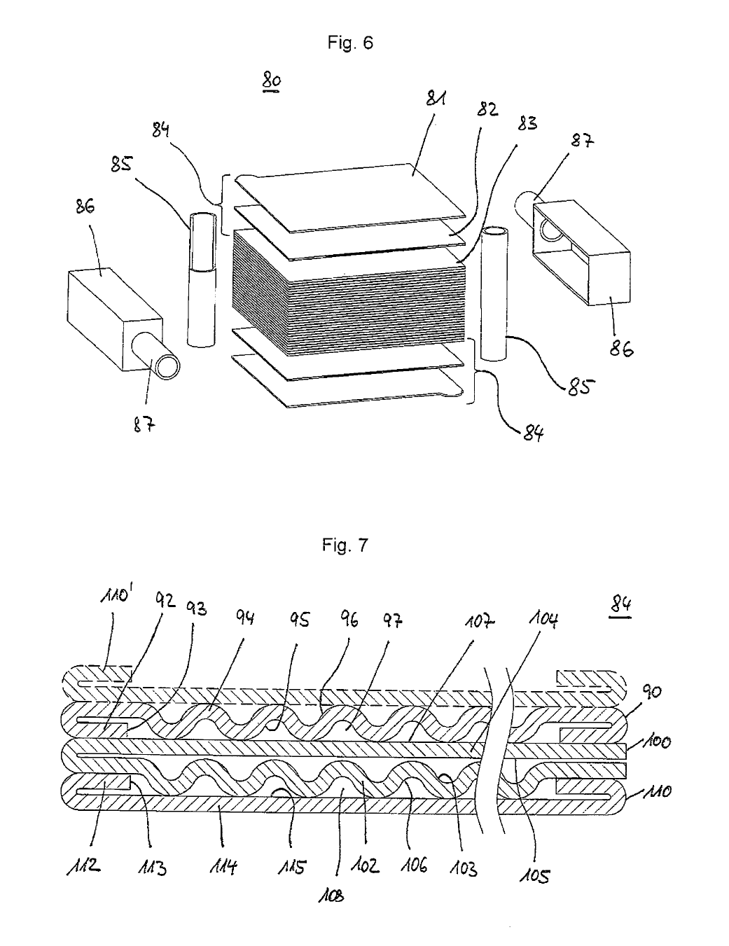

FIG. 6 shows a sample embodiment of the microfluidic reactor of the invention in an exploded view. The microfluidic reactor 80 in this example is a so-called heat exchange plate reactor. It consists, in the example shown, of three different microfluidic components or modules 81, 82, 83, stacked one on top of another and assembled into a reactor module 84. Several of the reactor modules 84 are then stacked one on another in turn and welded fluid-tight along their circumference, except for specific openings. In order to introduce a fluid, tubes 85 cut in half along the height of the reactor stack are mounted and welded at two opposite end faces of the reactor stack, preferably being fabricated from the same material as the microfluidic components and consisting preferably of refined steel. Along the end faces of the reactor stack perpendicular to this, opposite-lying fluid distributing boxes 86 preferably also of refined steel are mounted and welded on, each of them having a fluid inlet and outlet 87.

Such a reactor module 84 made from three microfluidic components is shown in cross section in FIG. 7. The reactor module 84 in this embodiment consists of three different microfluidic components stacked one on another, namely, a reformer module 90, a burner module 100 and a cover module 110. A portion of this arrangement is shown in FIG. 7. The reformer module 90 corresponds in principle to the design shown in FIG. 4 and has a section 92 with a contoured edge 93 as well as a section 94 with a structured surface 95. In turn, the structuring extends as a corrugation through the metal sheet of the component, so that the opposite surface 96 of the section 94 has a structuring of complementary type.

The burner module 100 corresponds along the cross section shown here to the design of FIG. 2 with a first section 102, which has a structured surface 103, and a second section 104, which has an unstructured surface 105. The section 102, in turn, has a corrugated structuring, so that it also has a structured surface 106 on the outside of the burner module 100. The burner module 100, for example, can be constructed like the microfluidic component in FIG. 1A to 1F. It would then happen that the module has three sections with contoured edges along a cross section perpendicular to the cross section shown here, defining open fluid distributors.

The cover module 110 is a microfluidic component according to the design of FIG. 3. It has a section 112 with a contoured edge 113 and a section 114 with an unstructured surface 115.

The three microfluidic components are stacked on top of each other such that the unstructured surface 115 of the cover module 110 adjoins the structured surface 106 on the outside of the burner module 100. The structured surface 95 of the section 94 of the reformer module 90 adjoins an unstructured outside of the second section 104 of the burner module 100 in surface-parallel manner.

In a stack of several such reactor modules 84, the upper side of the reformer module 90 would be adjoined by the next reactor module with the unstructured bottom side of its cover module 110′, shown by broken lines.

In this configuration, the open fluid lines configured by the structured inner surface 95 of the reformer module 90 together with the unstructured outer surface 107 of the second section 104 of the reactor module 100, and on the other side the open fluid lines configured by the structured outer surface 96 of the reformer module 90 together with the unstructured outer surface of the next cover module 110′ form closed fluid lines 97 of the burner module. The flow arrives in them at the end face across the fluid distributing box 86.

The burner module 100 itself forms first of all the mentioned closed fluid lines between the structured surface 104 and the unstructured surface 105. Moreover, the initially open fluid lines 108 formed by the structured surface 106 on the outside of the first section 102 of the burner module 100 together with the unstructured inner surface 115 of the section 114 of the cover module 110 form closed fluid lines 108. In this way, the number of closed channels of the burner module is increased. In order for all channels of the burner module to receive a good flow, the cover module 110 preferably has additional sections folded perpendicular to the plane of the drawing with contoured edge, which follow the corresponding contoured edges of the third sections of the burner module according to FIG. 1A to 1F. In this way, the fluid distributors (not seen here) extend laterally to the planes of the modules across the entire space between the inner surface 105 of the second section 104 of the burner module 100 and the inner surface 115 of the section 114 of the cover module 110.

FIG. 8 shows an alternative sample embodiment of a microfluidic reactor module 84′, corresponding to the reactor module 84 of FIG. 7 in structure, except for one difference. The reformer module 90′ has a section 92′ whose bending edge does not run perpendicular, but instead parallel to the plane of the drawing. Hence, the section 92′ appears as an unconnected element in the cross section depicted, not joined to the section 94′ with structured surface 95′, 96′ of the reformer module 90′.

FIG. 9 shows an alternative sample embodiment of a microfluidic reactor module 120, corresponding functionally to the reactor module 84, but consisting of only two microfluidic components, namely, a reformer module 90 and a burner module 121. The reformer module 90 corresponds in all details to the reformer module 90 of FIG. 7, so that we refer to the above description for this. However, a cover module is not needed in this reactor module 120. The reason is a modified design of the burner module 121, which consists of a first section 122 with a structured surface 123 and a second section 124 with an unstructured surface 125. Between the structured surface 123 of the first section 122 and the unstructured surface 125 of the second section 124 are configured closed fluid lines 128. In this respect, the burner module 121 also does not differ from the burner module 100 of FIG. 7. The difference is that the surface structure 123 is embossed on one side in the first section 122 of the metal sheet, so that the opposite surface 127 is unstructured. As a result, the folded metal sheet of the burner module 121 has unstructured surfaces 127 and 129 on both outer sides. The burner module 121 can therefore be oriented however desired with the one or other surface 127 or 129 pointing upward and adjoining the reformer module 90, and in each case it provides a structureless surface 129 on its bottom side for connection to the structured surface of the reformer module of the next reactor module.

The typical profile depths of the open and closed fluid lines are in the range of the sheet thicknesses of the corrugated metal sheets. This results from the circumstance that the overall thickness of a profiled section, i.e., the sum of profile depth and sheet thickness, must correspond to twice the sheet thickness, in order to compensate for a corresponding profiling by a once folded sheet with double sheet thickness, so that parallel stacks can be formed, see FIGS. 7 and 8. In the case of structures embossed on one side, the profile depths typically lie in the range of 10% to 60% of the sheet thickness. It follows from the indicated dimensions of the microfluidic structures that the metal sheet can be very thin, i.e., even a foil of several μm thickness.

Even though not demonstrated here by means of sample embodiments, it is obvious that metal sheet sections with multiple folding such that several layers of an integrally connected sheet lie surface-parallel on top of each other are to be considered part of the invention.

The width of the resulting open or closed fluid lines can vary according to the application. In the case of open or closed channels, the width lies in the range of 100 nm to 1 mm and is preferably on the order of magnitude of the profile depths, i.e., between 25 μm and 1 mm. In the case of pocket-shaped fluid distributors, the lateral dimension can be chosen arbitrarily and depends on the desired or required flow conditions.

### LIST OF REFERENCE NUMBERS

10 plate, rough blank
12 contour line, outer contour
21 first section of the metal sheet
22 second section of the metal sheet
23, 24 third section of the metal sheet
25, 26 contoured edge
27 depression, open fluid line, drain line
28 depression, open fluid line, delivery line
29, 30, 31, 32 projection
33, 34 opening, inlet and drain
41 first section
42 second section
44 bending edge
45 structured surface of the first section
46 unstructured surface of the second section
48 closed fluid line, closed channel
50 contoured edge
52 section with contoured edge
54 unstructured surface
56 section with unstructured surface
57 bending edge
58 open fluid line
60 contoured edge
62 section with contoured edge
64 structured surface
66 section with structured surface
67 bending edge
68 open fluid line
68′ first open fluid line
69 open fluid line on the outside
71 first section with structured surface
72 second section with structured surface
74 bending edge
75 structured surface
76 structured surface
78 closed fluid lines, channels
80 microfluidic reactor
81 first microfluidic component
82 second microfluidic component
83 third microfluidic component
84 reactor module
85 tubular fluid distributor
86 boxlike fluid distributor
87 inlet and drain
90, 90′ reformer module, microfluidic component
92, 92′ first section
93 contoured edge
94, 94′ second section
95, 95′ structured surface
96, 96′ structured surface
97 closed fluid line
100 burner module, microfluidic component
102 first section
103 structured surface
104 second section
105 unstructured surface
106 structured surface on the outside
107 unstructured surface on the outside
108 closed fluid line
110 cover module, microfluidic component
112 section with contoured edge
113 contoured edge
114 unstructured section
115 unstructured surface
120 reactor module
121 burner module, microfluidic component
122 first section
123 structured surface
124 second section
125 unstructured surface
127 unstructured surface of the first section
128 closed fluid line, channel
129 unstructured surface of the second section on the outside

What is claimed is:

1. A microfluidic component made from a metal sheet comprising: at least one first and/or second section having a structured or unstructured surface and at least one third section having a contoured edge which is folded such that the first and third and/or second and third sections integrally connected to each other are located on top of each other in a surface-parallel manner and the contoured edge forms a first wall section and the adjoining structured or unstructured surface forms a second wall section of an open fluid line.

2. A microfluidic component made of the metal sheet having a structure which comprises a closed fluid line, according to claim 1, wherein the closed fluid line is formed of a structured surface of the first section of the metal sheet and an adjoining structured or unstructured surface of the second section of the metal sheet, wherein the metal sheet is folded such that the first and second sections integrally connected to each other are located on top of each other in a surface-parallel manner.

3. The microfluidic component according to claim 1, wherein the structured surface is an embossed surface.

4. The microfluidic component according to claim 1, wherein the structured surface is corrugated.

5. The microfluidic component according to claim 2, wherein the closed fluid line forms a closed channel that empties into the open fluid line.

6. The microfluidic component according to claim 5, wherein the open fluid line is a collecting or distributing structure for bringing together a fluid from several of the closed channels or distributing the fluid to several of the closed channels.

7. The microfluidic component according to claim 2, wherein the structured surface of the first section and/or the structured or unstructured surface of the second section is coated at least in the region of the closed and/or open fluid line.

8. A microfluidic reactor, wherein several microfluidic components according to claim 1 are stacked and connected fluid-tight along their circumference except for specified openings.

9. The microfluidic reactor according to claim 8, wherein at least one of the several microfluidic components with an open fluid line adjoins a neighboring microfluidic component such that the open fluid line and the structured or unstructured surface of a first or second section of the adjoining component form a closed fluid line.

10. A method for making a microfluidic component, comprising the steps of: folding a metal sheet with at least one first and/or second section having a structured or unstructured surface and at least one third section having a contoured edge so that the third section with the contoured edge comes to lie surface-parallel on top of the first and/or second section with the structured or unstructured surface and the contoured edge forms a first wall section and the adjoining (after the folding) structured or unstructured surface forms a second wall section of an open fluid line.

11. The method for production of a microfluidic component, especially according to claim 10, wherein the metal sheet with at least one first section having a structured surface and at least one second section having a structured or unstructured surface is folded so that the first section comes to lie surface-parallel on top of the second section and the structured surface of the first section together with the adjoining structured or unstructured surface of the second section form a closed fluid line.

12. The method according to claim 10, wherein the structured surface is produced in an embossing step prior to the folding.

13. The method according to claim 12, wherein the structured surface is produced by embossing a corrugated structure.

14. The method according to claim 12, wherein embossing and folding occur in succession in a progressive composite die.

15. The method according to claim 10, wherein the contoured edge is produced in a punching step prior to the folding.

16. The method according to claim 11, wherein the metal sheet is folded such that the closed fluid line forms a closed channel that empties into the open fluid line.

17. The method according to claim 11, wherein the punching, embossing and folding occur in succession in a progressive composite die.

18. The method according to claim 11, wherein the structured surface of the first section and/or the structured or unstructured surface of the second section is coated at least in the region of the closed and/or open fluid line.

19. The method according to claim 18, wherein the structured surface of the first section and/or the structured or unstructured surface of the second section is coated in the silk screen process.

20. The method for making a microfluidic reactor, in which several microfluidic components are produced according to claim 11, wherein the several microfluidic components after the folding are layered one on top of the other and welded fluid-tight along their circumference, except for specified openings.

21. The method according to claim 20, wherein at least one of the several microfluidic components, forms an open fluid line which is closed upon layering of the structured or unstructured surface of a section of an adjacent component one on top of the other.

22. The method according to claim 20, wherein the several microfluidic components are laser welded.
